(19) United States
(12) Patent Application Publication
(10) Pub. No.: US 2008/0117402 A1
(43) Pub. Date: May 22, 2008

(54) Lithographic apparatus and method

(75) Inventors: Keith Frank Best, Best (NL); Cheng-Qun Gui, Best (NL); David Christopher Ockwell, Waalre (NL); Peter Ten Berge, Eindhoven (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 11/642,987

(22) Filed: Dec. 21, 2006

Related U.S. Application Data
(60) Provisional application No. 60/859,940, filed on Nov. 20, 2006.

(51) Int. Cl. G03B 27/58

(52) U.S. Cl. 355/72

(57) ABSTRACT

In an embodiment, a ring seal forming apparatus is disclosed, the apparatus including a substrate holder arranged to hold a substrate coated at least in part with resist, and a heating device configured to heat an area of the resist, relative movement between the substrate holder and heating device being possible, the movement being arranged such that, in use of the apparatus, the area of resist heated by the heating device is ring-shaped.

This non-provisional application claims the benefit of and priority to U.S. Provisional Application No. 60/859,940, filed Nov. 20, 2006, the entire contents of which application is hereby incorporated by reference.

### FIELD

The present invention relates to a lithographic apparatus and method.

### BACKGROUND

A lithographic apparatus is a machine that applies a desired pattern onto a target portion of a substrate. Lithographic apparatus can be used, for example, in the manufacture of integrated circuits (ICs). In that circumstance, a patterning device, which is alternatively referred to as a mask or a reticle, may be used to generate a circuit pattern corresponding to an individual layer of the IC, and this pattern can be imaged onto a target portion (e.g. comprising part of, one or several dies) on a substrate (e.g. a silicon wafer) that has a layer of radiation-sensitive material (resist). In general, a single substrate will contain a network of adjacent target portions that are successively exposed. Known lithographic apparatus include so-called steppers, in which each target portion is irradiated by exposing an entire pattern onto the target portion in one go, and so-called scanners, in which each target portion is irradiated by scanning the pattern through the beam in a given direction (the “scanning”-direction) while synchronously scanning the substrate parallel or anti-parallel to this direction.

In some circumstances it may be desirable to ensure that a certain area of resist on, for example, an outer region of the substrate is readily removable. The outer region may, for example, be a peripheral region (e.g., an edge region) of the substrate.

One such circumstance occurs, for example, when “packaging” an IC (i.e. mounting onto a board). It has been conventional to use wires to connect an IC to a board. However, in recent years the distance between locations to which wires are to be bonded has become progressively smaller, and it has been more difficult to use wire bonding. A process which is known as flip-chip bumping is increasingly used to connect an IC to a board instead of using connection wires. In flip-chip bumping, solder (or some other metal) is provided at specific locations on each IC on a substrate. The substrate is inverted and bonded to a board, for instance by heating the solder such that it melts and then allowing it to cool again.

The solder (or other metal) may itself be provided at specific locations by a lithographic process. In such a process, the substrate, which may comprise a plurality of ICs, is provided with a layer of radiation-sensitive material (resist). A lithographic apparatus may be used to irradiate the resist and the resist subsequently selectively removed at the specific locations in which a solder “bump” is required (the person skilled in the art will appreciate that these regions may be either irradiated regions or non-irradiated regions, depending upon whether a positive or negative resist is used). The IC may then undergo an electroplating step to apply the solder to the IC at the specific locations. As will be appreciate, the process of electroplating involves an electrical connection made to the article onto which metal is to be deposited. Accordingly, the electroplating step needs a resist free area of the substrate to making the electrical connection.

### SUMMARY

While it may be sufficient to provide a single resist free point for making such an electrical connection, it may be advantageous to provide a continuous ring of resist free substrate around the outer region of the substrate. Such an arrangement may enable a more reliable electrical connection. Furthermore, a continuous resist free ring around the outer edge of the substrate allows an electroplating bath to be conveniently formed using the resist free region. For example, an upstanding wall may be provided on the resist free region of the substrate, such that the substrate forms the base of the electroplating bath.

In order, for example, to ensure that good electrical connection to the substrate can be made, the resist free ring should be continuous, resist free and not contaminated. To help ensure this, it may be useful to provide that a patterned region of the substrate does not significantly encroach upon or is immediately adjacent to the resist free region (or the region which is to be subsequently made resist free). This is so that, for example, a chemical, a solution, etc. used in the processing of the patterned area of the substrate does not leak onto or into the resist free region. Such leakage may be prevented by the formation of a barrier or seal around the patterned region, which is referred to as a ring seal.

It is desirable, for example, to provide a novel apparatus and method for forming such a ring seal.

According to an aspect of the invention, there is provided a ring seal forming apparatus, comprising:

a substrate holder arranged to hold a substrate coated at least in part with resist; and

a heating device configured to heat an area of the resist, relative movement between the substrate holder and heating device being possible, the movement being arranged such that, in use of the apparatus, the area of resist heated by the heating device is ring-shaped.

According to a further aspect of the invention, there is provided a lithographic apparatus provided with a ring seal forming apparatus, the ring seal forming apparatus comprising:

a substrate holder arranged to hold a substrate coated at least in part with resist; and

a heating device configured to heat an area of the resist,

wherein the substrate holder and heating device are arranged such that relative movement is possible between the substrate holder and the heating device in order to heat a ring of resist to form the ring seal.

According to a further aspect of the invention, there is provided a substrate provided with a ring seal, the ring seal having been formed by heating a ring of resist on the substrate.

According to a further aspect of the invention, there is provided a method of forming a ring seal on a substrate coated at least in part with resist, the method comprising heating a ring of resist on the substrate.

According to a further aspect of the invention, there is provided a lithographic method comprising forming a ring seal on a substrate coated at least in part with resist by heating a ring of resist on the substrate.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIG. 2 depicts a substrate, and a ring seal forming apparatus according to an embodiment of the present invention; and

FIGS. 3 to 6 depict operating principles of one or more embodiments of the present invention.

### DETAILED DESCRIPTION

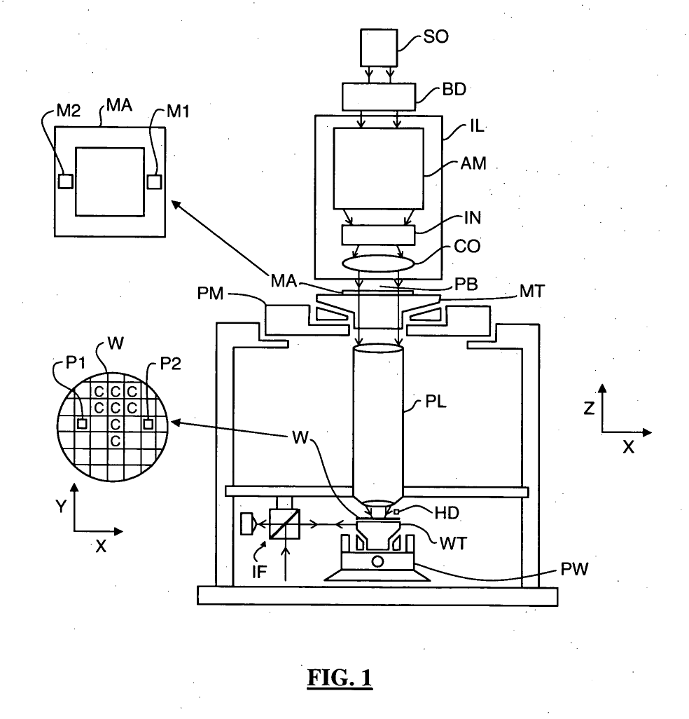

FIG. 1 schematically depicts a lithographic apparatus according to a particular embodiment of the invention. The apparatus comprises:
an illumination system (illuminator) IL to condition a beam PB of radiation (e.g. UV radiation or DUV radiation);
a support structure (e.g. a mask table) MT to support a patterning device (e.g. a mask) MA and connected to first positioning device PM to accurately position the patterning device with respect to item PL;
a substrate table (e.g. a wafer table) WT configured to hold a substrate (e.g. a resist-coated wafer) W and connected to second positioning device PW to accurately position the substrate with respect to item PL;
a projection system (e.g. a refractive projection lens) PL configured to image a pattern imparted to the radiation beam PB by patterning device MA onto a target portion C (e.g. comprising one or more dies) of the substrate W; and
a heating device HD configured to heat selected parts of the resist with which the substrate W is at least in part coated, the significance of which will be described in more detail below.

As here depicted, the apparatus is of a transmissive type (e.g. employing a transmissive mask). Alternatively, the apparatus may be of a reflective type (e.g. employing a programmable mirror array of a type as referred to above).

The term “patterning device” used herein should be broadly interpreted as referring to a device that can be used to impart a radiation beam with a pattern in its cross-section such as to create a pattern in a target portion of the substrate. It should be noted that the pattern imparted to the radiation beam may not exactly correspond to the desired pattern in the target portion of the substrate. Generally, the pattern imparted to the radiation beam will correspond to a particular functional layer in a device being created in the target portion, such as an integrated circuit.

A patterning device may be transmissive or reflective. Examples of patterning device include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions; in this manner, the reflected beam is patterned.

The support structure holds the patterning device. It holds the patterning device in a way depending on the orientation of the patterning device, the design of the lithographic apparatus, and other conditions, such as for example whether or not the patterning device is held in a vacuum environment. The support structure can use mechanical clamping, vacuum, or other clamping techniques, for example electrostatic clamping under vacuum conditions. The support structure may be a frame or a table, for example, which may be fixed or movable as required and which may ensure that the patterning device is at a desired position, for example with respect to the projection system. Any use of the terms “reticle” or “mask” herein may be considered synonymous with the more general term “patterning device”.

The term “projection system” used herein should be broadly interpreted as encompassing various types of projection system, including refractive optical systems, reflective optical systems, and catadioptric optical systems, as appropriate for example for the exposure radiation being used, or for other factors such as the use of an immersion fluid or the use of a vacuum. Any use of the term “projection lens” herein may be considered as synonymous with the more general term “projection system”.

The illumination system may also encompass various types of optical components, including refractive, reflective, and catadioptric optical components for directing, shaping, or controlling the beam of radiation, and such components may also be referred to below, collectively or singularly, as a “lens”.

The lithographic apparatus may be of a type having two (dual stage) or more substrate tables (and/or two or more support structures). In such “multiple stage” machines the additional tables and/or support structures may be used in parallel, or preparatory steps may be carried out on one or more tables and/or support structures while one or more other tables and/or support structures are being used for exposure.

The lithographic apparatus may also be of a type wherein the substrate is immersed in a liquid having a relatively high refractive index, e.g. water, so as to fill a space between the final element of the projection system and the substrate. Immersion liquids may also be applied to other spaces in the lithographic apparatus, for example, between the mask and the first element of the projection system. Immersion techniques are well known in the art for increasing the numerical aperture of projection systems.

The illuminator IL receives a beam of radiation from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising for example suitable directing mirrors and/or a beam expander. In other cases the source may be integral part of the apparatus, for example when the source is a mercury lamp. The source SO and the illuminator IL, together with the beam delivery system BD if required, may be referred to as a radiation system.

The illuminator IL may comprise adjusting means AM for adjusting the angular intensity distribution of the beam. Generally, at least the outer and/or inner radial extent (commonly referred to as σ-outer and σ-inner, respectively) of the intensity distribution in a pupil plane of the illuminator can be adjusted. In addition, the illuminator IL generally comprises various other components, such as an integrator IN and a condenser CO. The illuminator provides a conditioned beam of radiation PB, having a desired uniformity and intensity distribution in its cross-section.

The radiation beam PB is incident on the patterning device (e.g. mask) MA, which is held on the support structure MT. Having traversed the patterning device MA, the beam PB passes through the projection system PL, which focuses the beam onto a target portion C of the substrate W. With the aid of the second positioning device PW and position sensor IF (e.g. an interferometric device), the substrate table WT can be moved accurately, e.g. so as to position different target portions C in the path of the beam PB. Similarly, the first positioning device PM and another position sensor (which is not explicitly depicted in FIG. 1) can be used to accurately position the patterning device MA with respect to the path of the beam PB, e.g. after mechanical retrieval from a mask library, or during a scan. In general, movement of the object tables MT and WT will be realized with the aid of a long-stroke module (coarse positioning) and a short-stroke module (fine positioning), which form part of the positioning device PM and PW. However, in the case of a stepper (as opposed to a scanner) the support structure MT may be connected to a short stroke actuator only, or may be fixed. Patterning device MA and substrate W may be aligned using patterning device alignment marks M1, M2 and substrate alignment marks P1, P2.

The depicted apparatus can be used in the following preferred modes:

1. In step mode, the support structure MT and the substrate table WT are kept essentially stationary, while an entire pattern imparted to the beam PB is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the support structure MT and the substrate table WT are scanned synchronously while a pattern imparted to the beam PB is projected onto a target portion C (i.e. a single dynamic exposure). The velocity and direction of the substrate table WT relative to the support structure MT is determined by the (de-) magnification and image reversal characteristics of the projection system PL. In scan mode, the maximum size of the exposure field limits the width (in the non-scanning direction) of the target portion in a single dynamic exposure, whereas the length of the scanning motion determines the height (in the scanning direction) of the target portion.

3. In another mode, the support structure MT is kept essentially stationary holding a programmable patterning device, and the substrate table WT is moved or scanned while a pattern imparted to the beam PB is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

The lithographical apparatus described above may be used to form solder bumps in flip-chip bumping. The patterning device MA would be provided with a pattern which comprises the desired solder bumps. This pattern is imaged onto a thick layer of resist (i.e. thicker than a layer of resist used in conventional lithography) which is provided on the substrate W. The resist is then developed and processed such that recesses are formed at the locations where solder bumps are required. Solder is then electroplated in the recesses in the resist. The resist is then removed, so that the solder bumps project upwards from the uppermost surface of the substrate.

Accordingly, it will be appreciated that references herein to ‘substrate’ will include a substrate that already contains multiple processed layers (for example to form an IC).

As discussed above, it may sometimes be useful to prevent a patterned region from significantly encroaching upon or being immediately adjacent to the resist free region (or the region which is to be subsequently made resist free).

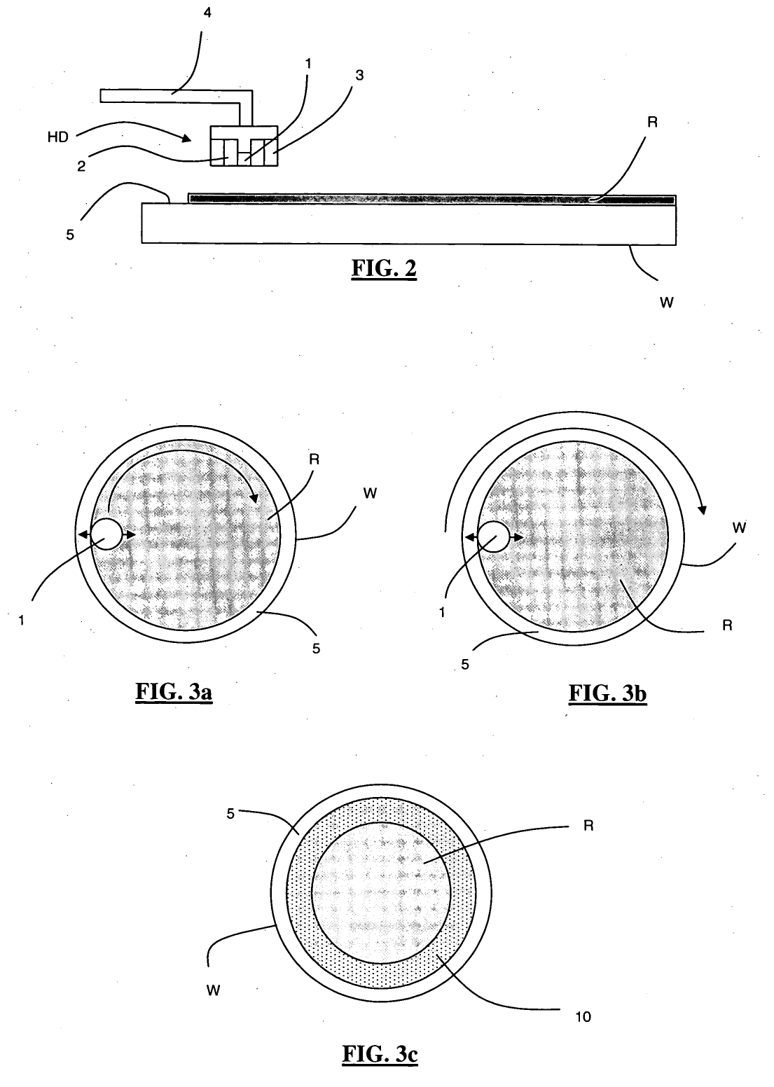

FIG. 2 illustrates the heating device HD in relation to the substrate W coated at least in part with resist R. The heating device HD is provided with an electronically controlled filament heater 1 which is located in a ceramic shell 2. The ceramic shell 2 and heater 1 are together housed within a hollow outer casing 3. The heating device HD is mounted on an armature 4. It can be seen that a resist free region 5 is provided on the outer edge of the substrate W, so that electrical connection to the substrate may be easily made.

In use, the heating device HD is located relative to the resist R on the substrate W by using the armature 4. The heater 1 is then activated to heat areas of resist R between the heating device HD and the substrate W. Different areas of resist R can be heated by either moving the heating device HD using the armature 4, or moving the substrate W relative to the heating device HD, or moving both the heating device HD and the substrate W relative to each other.

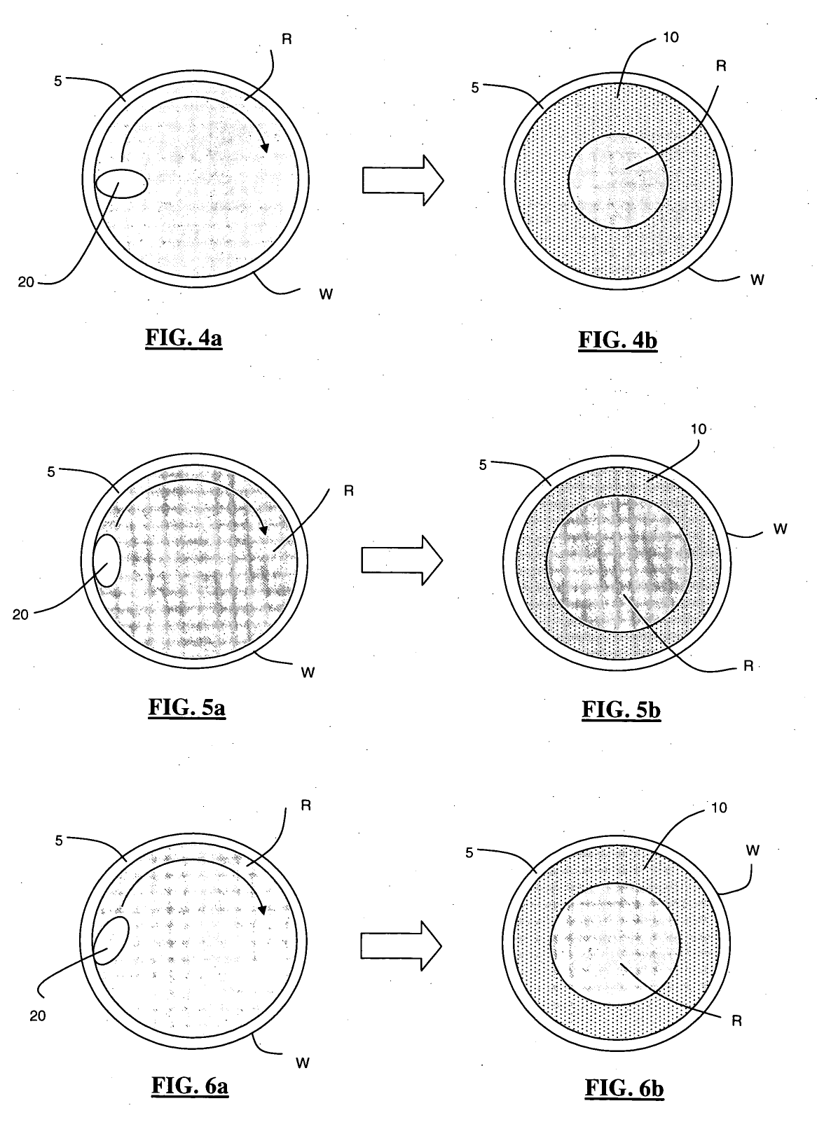

FIGS. 3a and 3b illustrate how different areas of the resist R may be heated using the heater 1. For clarity, the heater 1 is shown without the ceramic shell 2, hollow outer casing 3 and armature 4 (shown in FIG. 2), and is also exaggerated in size. It can be seen that the heater 1 has a circular footprint (although it may be another shape such as described below), in that the heater 1 heats a circular area of resist R which is located between the heater 1 and the substrate W. FIGS. 3a and 3b illustrate two embodiments for heating different areas of resist R. In FIG. 3a, it can be seen that the heater 1 may be moved radially with respect to the center of the substrate W, and also moved around the center of the substrate W. In this way, an arc or ring of resist R may be heated and the thickness of this arc or ring may be controlled by radial movement of the heater 1. In FIG. 3b, radial movement of the heater 1 is again possible, but the heater 1 is not moveable around the center of the substrate W. Instead, the substrate W is itself rotatable to bring different areas of resist R between the heater 1 and the substrate W. The substrate W may be rotated by the substrate table or holder which holds it in position (not shown in FIGS. 3 to 6). As will be appreciated, the embodiments of FIGS. 3a and 3b may be appropriately combined.

Photoresist, both negative and positive, typically contains a sensitizer that, when exposed to UV radiation reacts to form a chemical which is soluble in developer. Using either positive or negative resist, exposure or non-exposure of the resist can be used to create a pattern which is insoluble in developer (i.e. certain parts of the pattern are not removed when the resist is developed). However, this sensitizer can be removed and/or the resist cross-linked by appropriate heating of the resist. For example, referring back to FIG. 2, if the heater 1 of the heating device HD is positioned approximately 1 mm above the surface of the resist R and is used to heat the surface of the resist R to a temperature in the range of 100° C. to 450° C. the sensitizer can be removed from the resist and/or the resist made to cross-link. The resist becomes desensitized to UV radiation and becomes insoluble in developer. It will be appreciated that the exact temperature required to remove the sensitizer and/or cross-link the resist will depend on the type of resist used. In most applications, the temperature should not be sufficient to melt the resist.

FIG. 3c shows a ring shaped layer of desensitized resist 10 that may be formed using the heating arrangements described in relation to FIGS. 3a and 3b. This ring of resist 10 is desensitized to UV radiation. The ring of resist 10 is desensitized to UV radiation because it has become cross-linked and/or polymerized. If the desensitized ring of resist 10 was patterned before heating, the heating process will remove the pattern. If the ring 10 is formed (by heating) before being exposed to radiation, it cannot be patterned. Thus, the desensitized ring of resist 10 forms a barrier or seal (i.e. a ring seal) between a central region of the resist coated substrate W (which may be patterned) and an outer region 5 of the substrate W to which, for example, electrical connection may be made. The desensitized ring of resist 10 may also be used as a supporting structure for clamps or seals which are attached to the substrate W, for example to make electrical connection with the substrate W.

Referring back to FIG. 3a, the heater 1 was described as having a circular footprint. FIG. 4a illustrates a heater 20 having an elliptical footprint. Instead of moving the heater 20 in a radial direction relative to the center of the substrate W to define the width of a ring of resist R heated by the heater 20, the heater 20 is instead rotatable. The heater 20 may be constructed so that the long axis of its elliptical footprint corresponds to the largest required heated ring width, and so that its shortest axis corresponds to the smallest required heated ring width. The heater 20 may still be moveable in a radial direction to define the radius of the heated ring (e.g. so that the heated ring is adjacent to the resist free region 5).

FIG. 4a shows that, at one extreme, the long axis of the elliptical footprint of the heater 20 is aligned in a radial direction (with respect to the center of the substrate) to define the largest possible ring width of resist R that can be heated. The arrow shown in FIG. 4a indicates relative rotation between the substrate W and the heater 20. It will be appreciated that the heater 20 may be moved around the center of the substrate W, or the substrate W may be rotated beneath the heater 20, or both the heater 20 and the substrate W may be rotated relative to each other. FIG. 4b shows the desensitized ring of resist 10 formed by the heating process.

FIG. 5a shows that the heater 20 has been rotated such that the short axis of the elliptical footprint of the heater 20 is now aligned in the radial direction with respect to the center of a substrate W. This alignment ensures that the minimum possible ring width of resist R is heated. FIG. 5b shows the desensitized ring of resist 10 formed by the heating process, and that this ring of desensitized resist 10 is smaller in width than the desensitized ring of resist 10 shown in FIG. 4b.

FIG. 6a shows the heater 20 rotated to an intermediate position, between the two extremes illustrated in FIGS. 4a and 5a. In FIG. 6a, neither the long or short axis of the elliptical footprint of the heater 20 is aligned in the radial direction. This ensures that the width of the ring of resist R is between the width heated by the heater 20 in the orientations shown in FIGS. 4a and 5a. FIG. 6b shows the desensitized ring of resist 10 formed by the heating process. The width of the desensitized ring of resist 10 is between the widths of the desensitized rings 10 shown in FIGS. 4b and 5b.

In heating the resist R, it is possible that out-gassing may occur from a top surface of the resist R. It is desirable to remove any out-gassing components so that they do not contaminate other areas of the resist R. Referring back to FIG. 2, the hollow outer casing 3 may be used to exhaust out-gassing components from the top surface of the resist R (e.g., an outlet connected to a low pressure source).

It will be appreciated that the heating device HD described above is given by way of example only. Any sort of appropriate heating source may be used to heat the resist R, and this may be housed in any suitable way. For example, the heating device HD described above may be modified to incorporate a heat shield. The heat shield may extend from the heating device HD towards the resist R. This heat shield can be used to concentrate and/or direct the heat generated by the heater 1, and to prevent heating of adjacent areas of resist R that are not to be heated. Use of a heat shield may therefore lead to a more accurately defined heating footprint, which should in turn result in a more accurately defined heated ring of resist.

The heater 1 may be a heating filament which is electronically controlled. Alternatively, a heating tip similar to a soldering iron could be employed. In another example, infra-red radiation may be used as the heat source. Infra-red radiation emitted from an infra-red radiation source may be manipulated using a simple lens system. The simple lens system may be used to accurately control the shape and dimensions of the radiation which is incident on the resist R. For example, the lens system could be used to create a radiation beam having a spot width of approximately 100 μm, or any other suitable width. The infra-red radiation source may be housed in the casing 3 or be located elsewhere with the radiation transmitted via, for example, an optical fiber to the casing 3.

In another example, a heating device could be brought into physical contact with the resist R in order to heat it. In order to reduce the drag or friction on the resist caused by the heating device, the heating device could be made to rotate as it moves over the resist R, and/or the resist R moves beneath the heating device. For example, the heating device could be a heated wheel, roller or ball type structure. The heating device could be a heatable ring, which could be placed onto the resist R to heat a ring-shaped region. However, such a heatable ring may dissipate a lot of heat (due its large surface area in comparison with a small moveable heating element), which may cause distortion of some parts of the substrate or lithographic apparatus and/or cause other parts of the resist not to be heated. For this reason, the use of a heatable or heated ring may not be desirable.

The heating device used to heat the resist R may have a high heating intensity, so that it takes less time to heat a desired region of resist to a desired level and therefore takes less time to form, for example, a ring seal. Furthermore, using a more intense heating device for a shorter period of time reduces the diffusion of heat to areas of the resist which are not to be heated, thereby improving the definition of the boundaries of the heated areas of resist. Heating the resist for a short period of time reduces the probability of the resist melting or out-gassing. A shorter heating time also allows a thinner layer of desensitized resist (i.e. cross-linked and/or polymerized) to be formed, which may be beneficial.

The desensitized (i.e. cross-linked and/or polymerized) layer formed by the apparatuses and methods described above may be any desired thickness, so long as it is thick enough to prevent the resist underneath the desensitized layer from being developed. A typical layer of resist maybe 5 μm to 200 μm thick. In comparison, the desensitized layer maybe, for example greater than 200 nm thick, or in the range of 200 nm to 2 μm thick. The thicker the desensitized layer, the stronger it is. A thicker desensitized layer is also more robust to developer, for example. However, the thicker the desensitized layer, the more difficult it is to remove it (which may be necessary in later processing steps). The desensitized layer may be so thick that it is not possible, or is at least very difficult, to remove it using a chemical. It may well be that the desensitized layer can only be removed using a plasma. A thinner desensitized layer may be easily removed using an appropriate chemical. However, a thin desensitized layer is not as strong as a thicker layer, and will also be more susceptible to being dissolved in developer.

In the embodiments described above, the resist is heated directly. However, the resist R may be heated by a heating part of the underside of the substrate, the heat being conducted by the substrate to heat the resist. In contrast, it may be desirable to cool the underside of the substrate while heating of resist is taking place. Cooling of the substrate may prevent distortion of the substrates shape, or reduce the spread of heat from a heated region of resist to an unheated region of resist. The substrate may be cooled by immersing its underside in a fluid, such as water or gas. The fluid may be made to flow to ensure that cool fluid is continuously introduced to the underside of the substrate in order to cool the substrate more efficiently.

The heating of the resist R may be undertaken at any appropriate time. For example, heating of the resist R may be undertaken before, during or after exposure of the substrate W. However, it may be desirable to undertake the heating process after exposure and before the resist is developed, in order to eliminate or reduce any possible thermal disturbance to the exposure process caused by the heating process.

In FIG. 1, the heating device HD is shown as part of the lithographic apparatus. However, it will be appreciated that a separate unit may be provided to heat appropriate areas of the substrate. This unit may be part of the lithographic apparatus, connected to or in communication with the lithographic apparatus, or be stand-alone. The heating process could be undertaken at a pre-alignment location or stage, where the substrate is aligned ready for exposure or moved to after exposure.

In the embodiments described above, a desensitized ring 10 is shown as being formed using the heating processes. However, it will be appreciated that any appropriate pattern can be formed, for example a semi-circle or other arc type pattern or a rectangular, elliptical, etc. ring or shape.

In the embodiments described above, an exhaust has been described as being used to exhaust out-gassing components from the top surface of the resist R. It will be appreciated that the exhaust may also remove other gases and chemicals, for example heated gas in the vicinity of the substrate. Gas may be introduced in the environment in which heating is taking place in order to speed up the removal of the sensitizer and/or the cross-linking process, or to purge undesirable gases. The gas may be introduced using a nozzle (which may part of, for example, the heating device HD) which can direct the gas to a desired location, for example in between the heating device HD and the resist R.

The apparatus and method described have been discussed in relation to flip-chip bumping. However, it will be appreciated that the apparatus and method may be used for any desired purpose, not necessarily flip-chip bumping. The method and apparatus are particularly suitable to application where rings or arcs of resist need to be heated.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist) or a metrology or inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The terms “radiation” and “beam” used herein encompass all types of electromagnetic radiation, including ultraviolet (UV) radiation (e.g. having a wavelength of 365, 248, 193, 157 or 126 nm) and extreme ultra-violet (EUV) radiation (e.g. having a wavelength in the range of 5-20 nm), as well as particle beams, such as ion beams or electron beams.

While specific embodiments of the invention have been described above, it will be appreciated that the invention may be practiced otherwise than as described. The description is not intended to limit the invention.

1. A ring seal forming apparatus, comprising:
a substrate holder arranged to hold a substrate coated at least in part with resist; and
a heating device configured to heat an area of the resist, relative movement between the substrate holder and heating device being possible, the movement being arranged such that, in use of the apparatus, the area of resist heated by the heating device is ring-shaped.

2. The apparatus of claim 1, wherein the substrate holder is moveable relative to the heating device.

3. The apparatus of claim 2, wherein the substrate holder is rotatable.

4. The apparatus of claim 1, wherein the heating device is moveable relative to the substrate holder.

5. The apparatus of claim 4, wherein the heating device is moveable in a ring.

6. The apparatus of claim 4, wherein the heating device is moveable in a radial direction relative to the substrate holder.

7. The apparatus of claim 1, wherein the heating device has a circular heating footprint.

8. The apparatus of claim 1, wherein the heating device has an elliptical heating footprint

9. The apparatus of claim 1, wherein the heating device is rotatable.

10. The apparatus of claim 1, wherein the heating device comprises a filament.

11. The apparatus of claim 1, wherein the heating device comprises an infra-red radiation source.

12. The apparatus of claim 11, further comprising a lens system to control radiation emitted from the infra-red radiation source.

13. The apparatus of claim 1, further comprising an exhaust.

14. The apparatus of claim 13, wherein the heating device comprises the exhaust.

15. A lithographic apparatus provided with a ring seal forming apparatus, the ring seal forming apparatus comprising:
a substrate holder arranged to hold a substrate coated at least in part with resist; and
a heating device configured to heat an area of the resist,
wherein the substrate holder and the heating device are arranged such that relative movement is possible between the substrate holder and the heating device in order to heat a ring of resist to form the ring seal.

16. A substrate provided with a ring seal, the ring seal having been formed by heating a ring of resist on the substrate.

17. A method of forming a ring seal on a substrate coated at least in part with resist, the method comprising heating a ring of resist on the substrate.

18. The method of claim 17, wherein the ring of resist is heated to remove a pattern from the ring of resist, or to prevent the heated ring of resist from being patterned.

19. The method of claim 17, comprising rotating the substrate relative to a heating device used to heat the ring of resist.

20. The method of claim 17, comprising moving a heating device around the substrate to heat the ring of resist.

21. The method of claim 17, wherein the resist on the substrate is exposed to radiation to apply a pattern to the resist.

22. The method of claim 21, wherein the substrate is exposed to radiation after the ring of resist has been heated.

23. The method of claim 21, wherein the substrate is exposed to radiation before the ring of resist has been heated.

24. A lithographic method comprising forming a ring seal on a substrate coated at least in part with resist by heating a ring of resist on the substrate.
